(19) United States
(12) Patent Application Publication
(10) Pub. No.: US 2018/0046969 A1
(43) Pub. Date: Feb. 15, 2018

(54) TASK EXECUTION SUPPORT DEVICE, TASK EXECUTION SUPPORT SYSTEM, AND NON-TRANSITORY COMPUTER-READABLE STORAGE MEDIUM

(71) Applicant: FUJITSU LIMITED, Kawasaki-shi (JP)

(72) Inventors: Motoshi Sumioka, Kawasaki (JP); Masahide NODA, Kawasaki (JP); Kei TAIRA, Kita (JP); TAKUMI BABA, Kawasaki (JP); Takashi Ohno, Kobe (JP); Tatsuro Matsumoto, Yokohama (JP)

(73) Assignee: FUJITSU LIMITED, Kawasaki-shi (JP)

(21) Appl. No.: 15/653,383

(22) Filed: Jul. 18, 2017

(30) Foreign Application Priority Data
Aug. 12, 2016 (JP) 2016-159006

(51) Int. Cl. G06Q 10/06; G06Q 10/10

(52) U.S. Cl. CPC G06Q 10/063112; G06Q 10/10; G06Q 10/06; G06Q 10/06398; G06Q 10/06393; G06Q 10/063118; G06Q 10/06313

(57) ABSTRACT

A task execution support device stores information on a task processed in the past and information of a person in charge associated with the task; executes a process extracting, in response to a new task, a second task similar to the new task from the information on the task; executes a process identifying a person in charge who performed the second task from the information of a person in charge associated with the task and, calculating an evaluation value for the person in charge indicating contribution to the second task, the evaluation value being calculated based on how many times the person in charge has performed an operation of the second task and how many times the person in charge has requested the second task to another person in charge; and executes a process presenting a candidate for a person in charge, who is selected based on the evaluation value.

### CROSS-REFERENCE TO RELATED APPLICATION

This application is based upon and claims the benefit of priority of the prior Japanese Patent Application No. 2016-159006, filed on Aug. 12, 2016, the entire contents of which are incorporated herein by reference.

### FIELD

The embodiment discussed herein is related to a task execution support device, a task execution support system, a non-transitory computer-readable storage medium.

### BACKGROUND

As a task execution support system, there are systems for managing workflows that are patterns for repetitive task activities of working processes performed by workers. In such a task execution support system, first, a related party designs a workflow. The task execution support system then assigns a task to each worker to request that the work be performed. With a task execution support system, a manager can know the status of the requested work (the state of the progress of the work) and assign the next work to a worker who has completed the previous work. Utilizing the task execution support system, the manager can manage the progress from the start to the completion of the task.

There are human resource managing systems that determine skills of workers based on human resource information and case information and assign human resources to a task based on availability information on the schedule.

There are systems that estimate working time based on a past similar work and assign human resources based on the number of available man-hours of the worker and the skill thereof.

There are systems that can assign a work to a person in charge in accordance with the proficiency thereof.

There are systems that associate in advance individual information of potential workers with a plurality of groups forming a hierarchical structure such as departments in a company and thereby enable search of a responsible person or a person in charge in a department. Examples of the related art include Japanese Laid-open Patent Publication No. 2004-118648, Japanese Laid-open Patent Publication No. 2006-318331, Japanese Laid-open Patent Publication No. 2014-115852, and Japanese Laid-open Patent Publication No. 2004-62379.

### SUMMARY

According to an aspect of the invention, a task execution support device to manage tasks comprising: a memory configured to store information on a task processed in the past and information of a person in charge associated with the task processed in the past; and a processor coupled to the memory and configured to extract, in response to a new task, a second task similar to the new task from the information on the task processed in the past, execute a task execution support process that includes identifying a person in charge who performed the second task from the information of the person in charge associated with the task processed in the past, calculating, for the person in charge, an evaluation value indicating contribution to the second task, wherein the evaluation value is calculated based on how many times the person in charge has performed an operation of the second task and how many times the person in charge has assigned the second task to another person in charge, and presenting at least one candidate for a person in charge, the at least one candidate is selected based on the evaluation value, to perform the new task.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing device according to the embodiment;

FIG. 2 is a diagram illustrating an example of a new workflow;

FIG. 3 is a diagram illustrating an example of a process performed by an extraction unit;

FIG. 4 is a diagram illustrating an example of an evaluation result of a capability evaluation unit;

FIG. 5 is a diagram illustrating an example of an evaluation result of a feasibility evaluation unit;

FIG. 6 is a diagram illustrating an example of a determination process performed by a candidate determination unit;

FIG. 7 is a diagram illustrating an example of task tables included in a flow DB;

FIG. 8 is a diagram illustrating an example of a past-record table included in a past-record DB;

FIG. 9 is a diagram illustrating an example of a hardware configuration of the information processing device; and

FIG. 10A and FIG. 10B are flowcharts illustrating an example of a task execution support system according to the embodiment.

### DESCRIPTION OF EMBODIMENT

There is a system that assigns a worker for a task on a workflow (work assignment). A person in charge of assignment quantitatively determines a person who is skillful in a task of interest, a person who is available, or the like by using a task execution support system. The person in charge of assignment then selects an appropriate worker based on the determination result and assigns a new task to the selected worker.

In the actual working field, multiple persons may often cooperate to perform a task instead of a single person performing a task. However, the conventional task execution support system selects a candidate for a task based on an index of a skill or available time of an individual worker for a task. Thus, with a use of the conventional task execution support system, there may be a concern that the selected multiple persons do not necessarily function as a team in an actual case. In other words, no consideration is paid for data related to a personal relationship among worker candidates in a situation where there are multiple worker candidates, and therefore the conventional task execution support system is unable to determine whether or not the multiple worker candidates function as a team. In other words, in a situation where multiple worker candidates are involved, the conventional task execution support system is unable to present, to a person in charge of assignment, information for determining whether or not the multiple worker candidates function as a team.

As one aspect of the present embodiment, provided are solutions for supporting the determination of workers who can function as a team.

When designing a new workflow, it is not easy to determine which person is to be assigned each task of the workflow. Thus, an information processing device according to the embodiment extracts an associated past task from a database, focuses on a social connection of such as a person who performed the task and associated persons (or organization), and numerically evaluates (scores) their influences (contribution or the like) in performing a task. The information processing device determines one or more worker candidates to request a new workflow based on the numerical value indicating the influence. The information processing device can support a worker-determination operation performed by a designer by presenting information on the determined worker candidates to the workflow designer, for example. Alternatively, the information processing device may assign a new workflow to the selected worker candidates. The information processing device may ask approval of the workflow designer before assigning the new workflow.

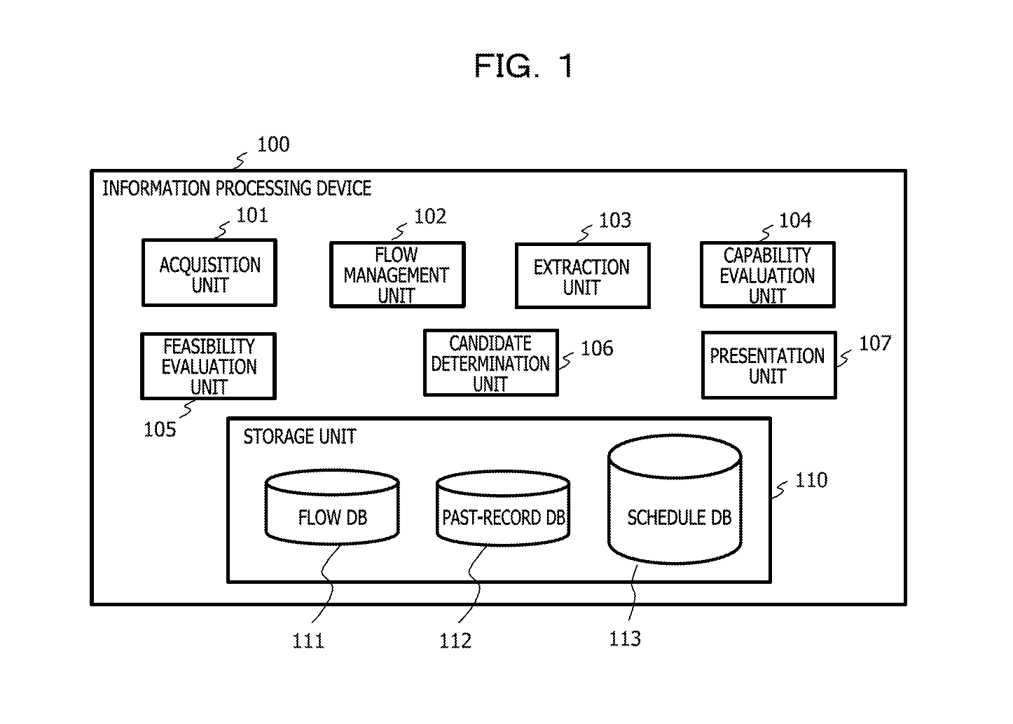

FIG. 1 is a diagram illustrating an example of an information processing device according to the embodiment. The information processing device 100 is a device that manages a workflow to support task execution. A workflow includes information on the order of a plurality of tasks, worker information indicating one or more workers assigned to each task, or the like. A storage unit 110 of the information processing device 100 stores a flow database (DB) 111 in which information on past workflows is accumulated, a past-record DB 112 in which information according to workers who were in charge of each task in past workflows is accumulated, and a schedule DB 113 containing schedule information of workers.

When a designer registers a new workflow, an acquisition unit 101 acquires information on a new workflow input by the designer. A designer may input a new workflow by using an input device or the like of the information processing device 100. Alternatively, a designer may input a new workflow from a client terminal that can communicate with the information processing device 100. A flow management unit 102 manages a process according to the design of a workflow in accordance with input by a designer. The flow management unit 102 registers the input workflow and task information included in the workflow to the flow DB 111. The flow management unit 102 registers information of workers assigned to each task to the past-record DB 112.

Once a new workflow is input, the information processing device 100 starts a process of presenting, to a workflow designer, one or more worker candidates to be assigned to a task in the new workflow. First, an extraction unit 103 extracts from the flow DB 111 a similar task that is similar to a new task included in the new workflow. With respect to a worker assigned to a similar task and a requester who has assigned the worker to the similar task, a capability evaluation unit 104 quantifies and evaluates a requesting capability and a working capability, respectively. The similar task may be also referred to as a second task.

The capability evaluation performed by the capability evaluation unit 104 is a value obtained by quantifying and multiplying the number of appearances in the past workflows, the contribution level in the workflows, and the like. A contribution level is a capability evaluation value that can be calculated as a sum of an assignment evaluation value (requesting capability), which is a ratio (between zero to one) of the tasks requested of the worker by the requester, and a worker evaluation value (working capability), which is a ratio (between zero to one) of the tasks performed by the worker.

Next, the feasibility evaluation unit 105 calculates a feasibility evaluation value that evaluates a feasibility as to whether or not a worker assigned to a similar task and a requester who has assigned the worker to the similar task are available for working when the task is actually assigned. To this end, the feasibility evaluation unit 105 acquires, from the schedule DB 113, the available time of the requester and the worker before the deadline of the new workflow. The feasibility evaluation value is obtained by dividing the available time of the requester and the worker before the deadline of the new workflow by the work time (past-record time) in the past workflows and multiplying the divided value by a certain safety ratio (for example, around one fifth).

A candidate determination unit 106 determines one or more candidates suitable to be assigned to a task of a new workflow, based on the evaluation performed by the capability evaluation unit 104 and the feasibility evaluation unit 105. The candidate determination unit 106 determines, as one or more candidates who are suitable to be assigned to a task of a new workflow, one or more candidates who have a higher product of the capability evaluation value and the feasibility evaluation value. A presentation unit 107 presents, to the designer, one or more candidates determined by the candidate determination unit 106.

As discussed above, the information processing device 100 according to the embodiment quantifies the assignment evaluation value (requesting capability) in a capability value evaluation, and what is to be evaluated is not only a skill of an individual but also the presence of a person who can cooperate with the individual. With determination of candidates from the past workflow who have a strong connection between the requester side and the worker side, candidates who have much experience in a team can be assigned to a new task, which enables the candidates to easily function as a team.

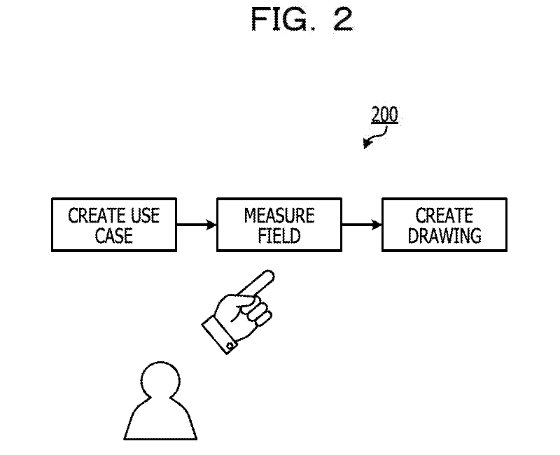

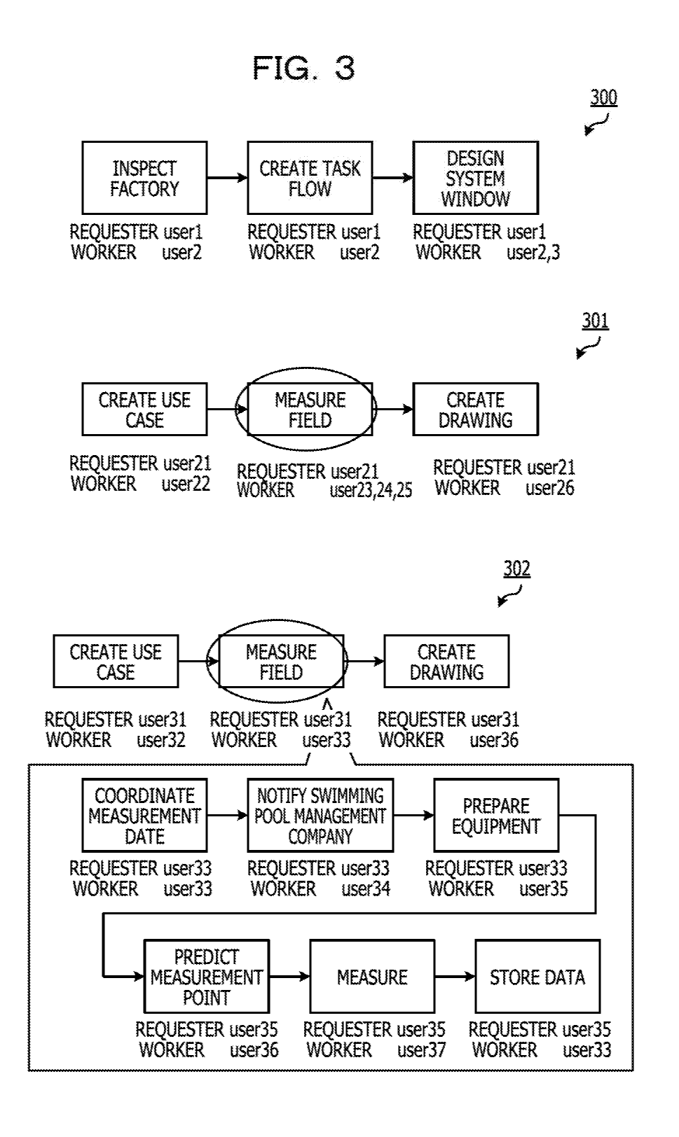

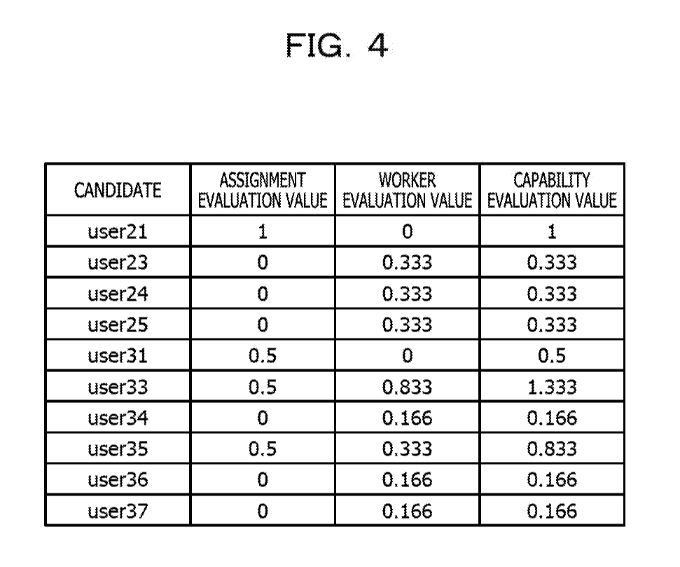

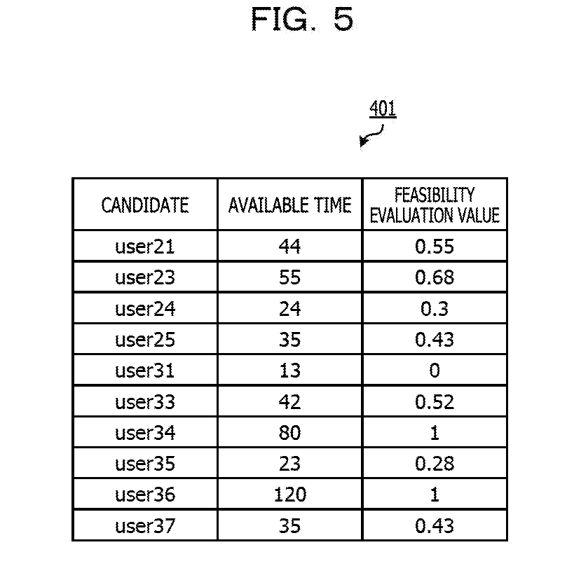

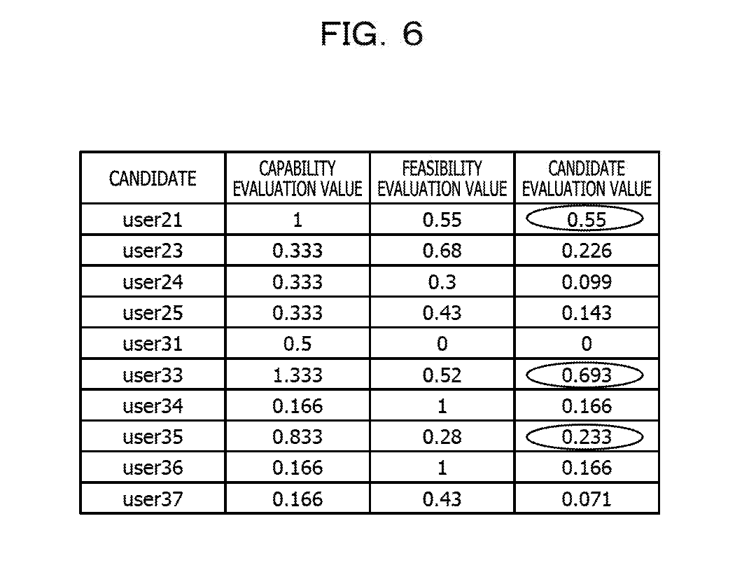

A candidate determination process according to the embodiment will be illustrated by using FIG. 2 to FIG. 6. FIG. 2 is a diagram illustrating an example of a new workflow. FIG. 3 is a diagram illustrating an example of a process performed by the extraction unit. FIG. 4 is a diagram illustrating an example of an evaluation result of the capability evaluation unit. FIG. 5 is a diagram illustrating an example of an evaluation result of the feasibility evaluation unit. FIG. 6 is a diagram illustrating an example of a determination process performed by the candidate determination unit.

A new workflow 200 of FIG. 2 is a workflow used in refurnishing a lobby of a building, for example. A designer inputs, into the information processing device 100, three tasks of “create a use case”, “measure the site”, and “create a drawing” for tasks in the lobby refurnishing as a new workflow 200.

When the designer intends to perform work of assigning one or more workers to the task of “measure the site”, the information processing device 100 starts a process of presenting, to the workflow designer, worker candidates to which a task of the new workflow is to be assigned. FIG. 3 illustrates an example of a past workflow 300 to a past workflow 302. The past workflow 300 is an example of a workflow according to development of quality control software of a food processing company and includes the tasks “inspect the factory”, “create a task flow”, and “design a system window”. Since there is no similar task in the past workflow 300 that is similar to the tasks included in the new workflow 200, the execution unit 103 excludes the tasks included in the past workflow 300 from the subsequent process.

The past workflow 301 is an example of a workflow according to renovation of a rest area and includes the three tasks “create a use case”, “measure the field”, and “create a drawing”. The past workflow 301 includes a similar task that is similar to the task “measure the field” of the new workflow 200. Therefore, the extraction unit 103 extracts the past workflow 301 as a workflow to be processed.

The past workflow 302 is an example of a workflow according to refurbishing of a municipal swimming pool and includes three tasks “create a use case”, “measure the field”, and “create a drawing”. The past workflow 302 includes a similar task that is similar to the task “measure the field” of the new workflow 200. Therefore, the extraction unit 103 extracts the past workflow 302 as a workflow to be processed.

Once the past workflow 301 and the past workflow 302 to be processed have been extracted, the capability evaluation unit 104 quantifies and evaluates the requesting capability and the working capability of a worker assigned to the similar task and a requester who has assigned the worker to the similar task (hereafter, a worker and a requester may be collectively referred to as persons in charge), respectively. A “user 21” is assigned as a requester, and a “user 23”, a “user 24”, and a “user 25” are assigned as workers to the similar task “measure the field” of the past workflow 301. The capability evaluation unit 104 thus evaluates the requesting capability and the working capability for the requester “user 21” and the workers “user 23”, “user 24”, and “user 25”, respectively.

FIG. 4 includes an evaluation result of the past workflow 301 by the capability evaluation unit 104. Since the “user 21” is the requester of the task “measure the field”, the capability evaluation unit 104 places 1 in the assignment evaluation value, which is the requesting capability of the “user 21”. Since the task “measure the field” was performed by three workers, the capability evaluation unit 104 evaluates the working capability (working ratio) of the “user 23”, “user 24”, and “user 25” to be 1/3. The capability evaluation unit 104 calculates the capability evaluation value by summing the values indicating the requesting capability and the working capability of the respective workers and requester. As a result, the capability evaluation value of the “user 21” is 1, and each capability evaluation value of the “user 23”, “user 24”, and “user 25” is 1/3.

Furthermore, FIG. 4 includes an evaluation result of the past workflow 302 by the capability evaluation unit 104. A “user 31” is assigned as a requester and a “user 33” is assigned as a worker to the similar task “measure the field” of the past workflow 302. A single task may include a plurality of subtasks. A task “measure the field” (parent task) of FIG. 3 includes a plurality of subtasks such as “coordinate a measurement date”, “notify the swimming pool management company”, “prepare equipment”, “predict measurement points”, “carry out measurement”, “store data”, or the like. In such a way, when a similar task includes subtasks, a requester and a worker of subtasks are to be evaluated by the capability evaluation unit 104. The capability evaluation unit 104 thus evaluates the requesting capability and the working capability for the requesters “user 31”, “user 33”, and “user 35” and the workers “user 33”, “user 34”, “user 35”, “user 36”, and “user 37”, respectively.

Although being a requester of the parent task, the “user 31” is not a requester of the subtask. It is therefore assumed that the “user 31” is a person responsible for middle-level management. The capability evaluation unit 104 multiplies the assignment evaluation value of the “user 31” who is a middle-level manager by an intermediate coefficient a (for example, 0.5) (namely, 1*0.5) to obtain a final assignment evaluation value. With respect to the intermediate coefficient α, the value of the intermediate coefficient α is set larger when placing more importance on middle-level management capability.

The “user 33” is a requester of three subtasks and a worker of the parent task and two subtasks. Because the “user 33” requested three subtasks out of six subtasks, the capability evaluation unit 104 sets the requesting capability to be 3/6 (that is, 0.5) to calculate the assignment evaluation value. Next, because the “user 33” carried out the parent task (middle-level management) and two subtasks out of six subtasks, the capability evaluation unit 104 sets the working capability to be 1*a+2/6 to calculate the working capability evaluation value.

The “user 34” is a worker of one subtask. Because the “user 34” carried out one subtask out of six subtasks, the capability evaluation unit 104 sets the working capability to be 1/6 to calculate the working capability evaluation value.

The “user 35” is a requester of three subtasks and a worker of two subtasks. Because the “user 35” requested three subtasks out of six subtasks, the capability evaluation unit 104 sets the requesting capability to be 3/6 (that is, 0.5) to calculate the assignment evaluation value. Next, because the “user 35” carried out two subtasks out of six subtasks, the capability evaluation unit 104 sets the working capability to be 2/6 to calculate the working capability evaluation value.

Each of the “user 36” and the “user 37” is a worker of one subtask. Each of the “user 36” and the “user 37” carries out one subtask of six subtasks, and therefore the capability evaluation unit 104 sets the working capability to be 1/6 to calculate the working capability evaluation value.

The capability evaluation unit 104 may calculate the capability evaluation value by adding a score regarding the requesting capability (requesting capability evaluation value) and a score regarding the working capability (working capability evaluation value), for example. According to the example described above, the capability evaluation unit 104 calculates the capability evaluation value of the “user 31” to be 0.5 (that is, the requesting capability score (1*0.5)+the working capability score (0)), the capability evaluation value of the “user 33” to be 1.333 (that is, the requesting capability score (3/6)+the working capability score (1*a+2/6)), the capability evaluation value of the “user 34” to be 0.166 (that is, the requesting capability score (0)+the working capability score (1/6)), the capability evaluation value of the “user 35” to be 0.833 (that is, the requesting capability score (3/6)+the working capability score (2/6)), and each capability evaluation value of the “user 36” and “user 37” to be 0.166 (that is, the requesting capability score (0)+the working capability score (1/6)). In the example described above, the working capability score corresponds to how many times a worker has carried out a similar task that is similar to a new task. The requesting capability score corresponds to how many times a requester has requested a similar task to other persons in charge (workers).

FIG. 5 is an example of an evaluation result evaluated by the feasibility evaluation unit 105 by quantifying the feasibility as to whether or not task assignment is possible in terms of the available time of each of the workers and the requesters from the start of a task to the deadline thereof. An evaluation result table 401 includes candidates of a new task, the available time of each candidate, and the feasibility evaluation value of each candidate. In this example, parameters such as a scheduled initiation (start) date of a task, a scheduled end date (deadline) of the task, an expected work time for the task, a margin, or the like are set for calculation of the feasibility evaluation value performed by the feasibility evaluation unit 105. The margin is a parameter used in allocating a time to a worker with extra time added to the expected work time for a task.

The candidates of the evaluation result table 401 may include a requester and a worker evaluated by the capability evaluation unit 104. The available time of the evaluation result table 401 is a numerical value that represents the available time from a scheduled initiation (start) date of a task to a scheduled end date of the task obtained from the schedule DB 113.

The feasibility evaluation value may be determined based on a value calculated by dividing available time by a value obtained by multiplying expected work time by a margin value. The feasibility evaluation unit 105 evaluates the feasibility evaluation value as a value between 0 to 1. When the available time is greater than the value obtained by multiplying the expected work time by the margin value, the feasibility evaluation unit 105 sets the feasibility evaluation value to 1 (see, for example, the user 36). On the other hand, when the available time is less than the value obtained by multiplying the expected work time by the margin value, the feasibility evaluation unit 105 sets the feasibility evaluation value to 0 (see, for example, the user 31). In other words, the feasibility evaluation value may be determined based on a value obtained by dividing available time by a value obtained by adding some margin value to the expected work time. Alternatively, the feasibility evaluation value may be determined based on a value obtained by dividing available time by a sum of the expected work time and some margin value. For example, when a value obtained by dividing available time by a sum of the expected work time and some margin value is a positive value, the feasibility evaluation unit 105 may set the feasibility evaluation value to “1”. In contrast, when a value obtained by dividing available time by a sum of the expected work time and some margin value is a negative value, the feasibility evaluation unit 105 may set the feasibility evaluation value to “0”.

Once the capability evaluation value and the feasibility evaluation value are calculated, the candidate determination unit 106 calculates a candidate determination evaluation value. FIG. 6 illustrates an example of an evaluation result of candidate determination evaluation values. The candidate determination unit 106 multiplies a capability evaluation value by a feasibility evaluation value to calculate a candidate determination evaluation value. The candidate determination unit 106 prioritizes and determines, as a candidate, a worker (a requester) having a high candidate determination evaluation value. For example, the candidate determination unit 106 may sort workers (requesters) in descending order of candidate determination evaluation value and determine, as candidates, the predetermined number of workers (requesters) in descending order of candidate determination evaluation value. In the example of FIG. 6, the three users “user 21”, “user 33”, and “user 35” are determined to be worker candidates having a high candidate determination evaluation value. The presentation unit 107 supports the candidate determination unit 106 displaying worker candidates on a monitor and a worker determination operation performed by a workflow designer. For example, the designer may determine the assignment of a new task by selecting one or more candidates from the worker candidates displayed on the monitor.

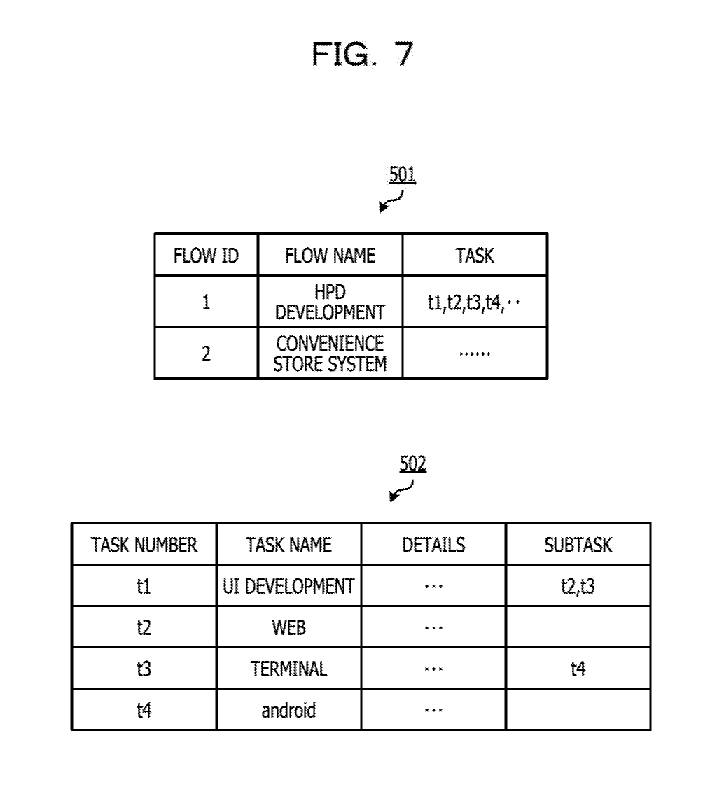

FIG. 7 is a diagram illustrating an example of a task table included in a flow DB. The flow DB 111 includes a task table 501 illustrating a connection between a workflow and a task included in the workflow and a task table 502 illustrating a connection between a task and a subtask. The task table 501 includes items of flow identification number (ID), flow name, and task. The item, flow identification number, is a number allocated for identifying each flow. The item, flow name, is a name registered by a designer to each flow. In the item, task, in the task table 501, task numbers corresponding to respective workflows are registered in the order of tasks in a workflow.

The task table 502 includes items of task number, task name, details, and subtask. The item “task number” is an identification number for identifying each task. The item “task name” is a name registered by a designer to each task. The item “details” is detailed work content information of a task registered by a designer to each task. The item “subtask” includes numbers for identifying subtasks associated with a task and the numbers are registered in the order of subtasks in a task.

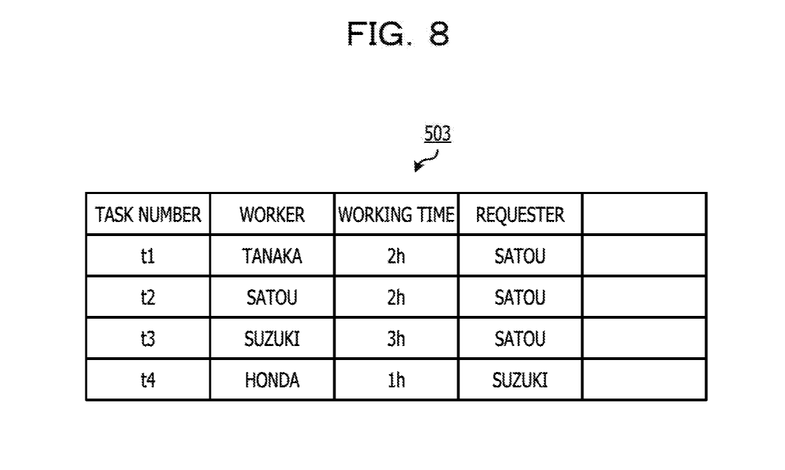

FIG. 8 is a diagram illustrating an example of a past-record table included in a past-record DB. The past-record table 503 includes items of task number, worker, execution time, and requester. The past-record table 503 has the same numbers as those in the task table 502 for the same task. The item “worker” is information indicating workers assigned to each task. The item “execution time” is working time taken by a worker to execute a task. The item “requester” is information indicating a person who has requested (registered) each task.

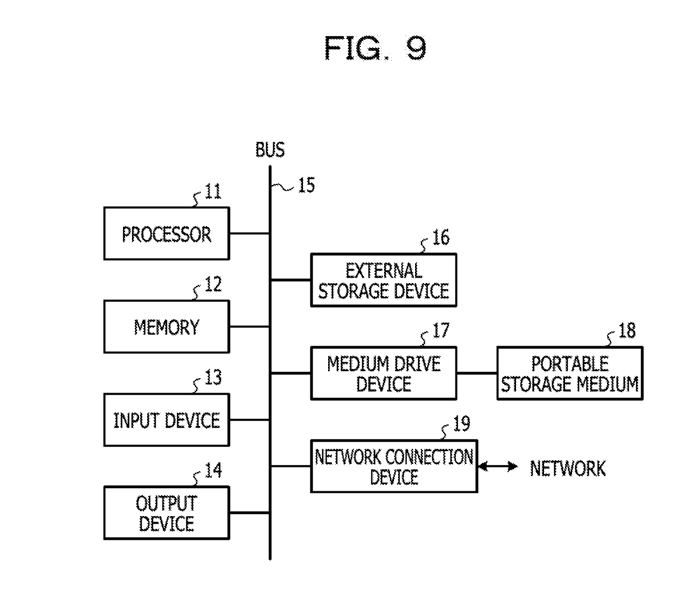

FIG. 9 is a diagram illustrating an example of a hardware configuration of the information processing device. The information processing device 100 has a processor 11, a memory 12, a bus 15, an external storage device 16, and a network connection device 19. Furthermore, optionally, the information processing device 100 may have an input device 13, an output device 14, and a medium drive device 17. For example, the information processing device 100 may be implemented with a computer or the like.

The processor 11 may be any processing circuit including a central processing unit (CPU). The processor 11 operates as the acquisition unit 101, the flow management unit 102, the extraction unit 103, the capability evaluation unit 104, the feasibility evaluation unit 105, and the candidate determination unit 106. Note that the processor 11 can execute a program stored in the external storage device 16. In other words, with execution of a program, the processor 11 can serve as a hardware circuit that is able to execute processes for the acquisition unit 101, the flow management unit 102, the extraction unit 103, the capability evaluation unit 104, the feasibility evaluation unit 105, and the candidate determination unit 106. The memory 12 operates as the storage unit 110 and stores the flow DB 111, the past-record DB 112, and the schedule DB 113. Furthermore, the memory 12 can store data obtained through the operation of the processor 11 or data used in the process of the processor 11. The network connection device 19 is used for communication with other devices.

The input device 13 is implemented as a button, a keyboard, a mouse, or the like, for example, and the output device 14 is implemented as a display. The output device 14 operates as the presentation unit 107. The bus 15 connects the processor 11, the memory 12, the input device 13, the output device 14, the external storage device 16, the medium drive device 17, and the network connection device 19 so as to enable transfer of data among these devices. The external storage device 16 stores a program or data and can provide the stored information to the processor 11. The medium drive device 17 can output data of the external storage device 16 or the memory 12 to a portable storage medium 18, or can read a program, data, or the like from the portable storage medium 18. The portable storage medium 18 may be any portable storage medium including a floppy disk, a magnet-optical (MO) disk, a compact disk recordable (CD-R), or a digital versatile disk recordable (DVD-R).

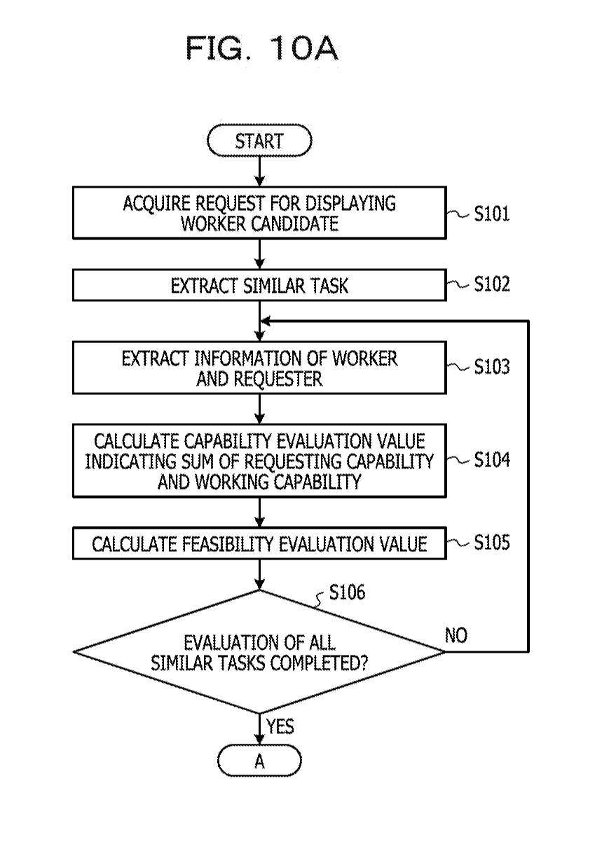

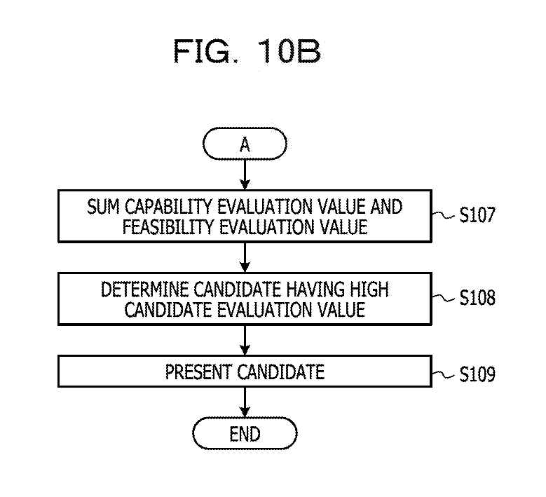

FIG. 10A through FIG. 10B are flowcharts illustrating an example of a process of the task execution support system according to the embodiment. The acquisition unit 101 acquires a request for a designer to display worker candidates of a registered task (step S101). The extraction unit 103 extracts a similar task that is similar to the registered task (step S102). The extraction unit 103 extracts information of a request and a worker of the similar task from the past-record DB 112 (step S103). The capability evaluation unit 104 calculates a capability evaluation value that indicates a sum of the requesting capability and the working capability of the requester and the worker, respectively, of a similar task (step S104). The feasibility evaluation unit 105 calculates the feasibility evaluation values of the requester and the worker, respectively, of the similar task (step S105).

The feasibility evaluation unit 105 determines whether or not the evaluation has been completed for all the similar tasks (step S106). If the evaluation has not been completed for all the similar tasks (step S106, NO), the information processing device 100 repeats the process from step S103.

If the evaluation has been completed for all the similar tasks (step S106, YES), the candidate determination unit 106 sums the capability evaluation value and the feasibility evaluation value (step S107). The candidate determination unit 106 prioritizes and determines as candidates a worker (a requester) having a high candidate determination evaluation value, which is obtained by adding the capability evaluation value and the feasibility evaluation value (step S108). The presentation unit 107 presents a worker and a requester determined as candidates (step S109). Upon the completion of the process of step S109, the information processing device 100 ends the process of presenting worker candidates according to the embodiment.

In the task execution support system according to the embodiment, another evaluation may be added to requesting capability, working capability, feasibility, or the like.

When a part of the persons who are in charge of a past workflow is unavailable and when another worker is replaced therewith, an initial cost that occurs due to addition of an unfamiliar person may be added to the evaluation value.

When a unit price of a worker is known, the unit price of each worker may be added to the cost to be evaluated and such evaluation may be considered in determination of a worker candidate.

One who has a high ratio of completed tasks in the current workflow is enthusiastic or has a sense of responsibility, and thus α may be added to the feasibility evaluation value of the candidate of this task. On the other hand, for a candidate who has many items of “postpone” or “extension” in the current workflow, a may be subtracted from the feasibility evaluation value. This allows for coordination of evaluation value in accordance with a progress state.

It may be determined that the skill of a worker is more accurately reflected in a new workflow than in an old workflow in the past workflow, and therefore the capability of a worker in the new workflow may be weighted.

The method of capability evaluation of a requester and a worker may be changed in accordance with a deadline of a workflow. For example, when there is enough time before the deadline of a workflow, evaluation of a person having a high assigning capability may be increased. On the other hand, when there is not enough time before the deadline of a workflow, evaluation of a person having a high working capability may be increased. Thereby, the desirable capability of a worker can be changed in accordance with the deadline.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A task execution support device to manage tasks comprising:
a memory configured to store information on a task processed in the past and information of a person in charge associated with the task processed in the past; and
a processor coupled to the memory and configured to
extract, in response to a new task, a second task similar to the new task from the information on the task processed in the past,
execute a task execution support process that includes
identifying a person in charge who performed the second task from the information of the person in charge associated with the task processed in the past,
calculating, for the person in charge, an evaluation value indicating contribution to the second task, wherein the evaluation value is calculated based on how many times the person in charge has performed an operation of the second task and how many times the person in charge has assigned the second task to another person in charge, and
presenting at least one candidate for a person in charge, the at least one candidate is selected based on the evaluation value, to perform the new task.

2. The task execution support device according to claim 1, wherein the task execution support process further includes evaluating a feasibility as to whether or not the person in charge can take charge of the new task taking into consideration a margin value with respect to an available time of the person in charge in a period scheduled for performing the new task.

3. A task execution support system to manage tasks comprising:
at least one database configured to store information on a task processed in the past and information of a person in charge associated with the task processed in the past;
an input device configured to receive a new task;
a processor configured to perform a task execution support process that includes
extract, in response to the new task, a second task similar to the new task from the at least one database;
identify a person in charge who performed the second task from the information of the person in charge associated with the task processed in the past and,
calculate, for the person in charge, an evaluation value indicating contribution to the second task, wherein the evaluation value is calculated based on how many times the person in charge has performed an operation of the second task and how many times the person in charge has assigned the second task to another person in charge, and
determine at least one candidate for a person in charge of the new task based on the evaluation value; and
an output device configured to display the at least one candidate to a user of the information processing device.

4. The task execution support system according to claim 3, wherein the evaluation value is based on numerical values assigned to at least one of an assignment evaluation value, a worker evaluation value and feasibility evaluation value.

5. The task execution support system according to claim 4, wherein at least one of the assignment evaluation value, the worker evaluation value and the feasibility evaluation value is a weighted value.

6. The task execution support system according to claim 3, wherein
the input device is further configured to receive an input selecting a person from the displayed at least one candidate as the person in charge of the new task, and
the processor is further configured to update the at least one database to include information of the new task and the person in charge of the new task.

7. A non-transitory computer-readable storage medium for storing a program that causes a processor to execute a task execution support process, the processor coupled to a memory configured to store information on a task processed in the past and information of a person in charge associated with the task processed in the past, the task execution support process comprising:
extracting, in response to a new task, a second task similar to the new task from the information on the task processed in the past,
executing a task execution support process that includes
identifying a person in charge who performed the second task from the information of the person in charge associated with the task processed in the past,
calculating an evaluation value for the person in charge indicating contribution to the second task, wherein the evaluation value is calculated based on how many times the person in charge has performed an operation of the second task and how many times the person in charge has assigned the second task to another person in charge, and
presenting at least one candidate for a person in charge, the at least one candidate is selected based on the evaluation value, to perform the new task.
